(19) United States
(12) Patent Application Publication
(10) Pub. No.: US 2024/0236614 A1
(43) Pub. Date: Jul. 11, 2024

(54) SOUND SOURCE REPRODUCTION DEVICE, SOUND SOURCE REPRODUCTION METHOD, AND PROGRAM

(71) Applicant: NIPPON TELEGRAPH AND TELEPHONE CORPORATION, Tokyo (JP)

(72) Inventor: Kazu MIYAKAWA, Tokyo (JP)

(73) Assignee: NIPPON TELEGRAPH AND TELEPHONE CORPORATION, Tokyo (JP)

(21) Appl. No.: 18/561,273

(22) PCT Filed: May 21, 2021
(86) PCT No.: PCT/JP2021/019432

§ 371 Date: Nov. 15, 2023

(51) Int. Cl. H04S 7/00

(52) U.S. Cl. CPC H04S 7/40; H04S 2400/11

(57) ABSTRACT

A sound source reproduction device (1) includes: a sound source input unit (11) that inputs sound source information recorded in advance in synchronization with time information; a sound source position input unit (12) that inputs position information of a first sound source at the time; a first sound source attribute input unit (13) that inputs first sound source attribute information for expressing an attribute of the first sound source at the time by using an image and reproducing the attribute in a real space; a sound source synthesis unit (14) that generates a first virtual sound source for reproducing the first sound source in the real space by using the first sound source information and the sound source position information at the time; a sound source reproduction unit (15) that reproduces the virtual sound source in the real space; a first sound source attribute synthesis unit (16) that generates a sound source attribute synthesis image for reproducing the attribute information of the first sound source in the real space by using the position information of the first sound source and the first sound source attribute information; and a sound source attribute display unit (17) that displays the sound source attribute synthesis image in the real space.

### TECHNICAL FIELD

The present invention relates to a sound source reproduction device, a sound source reproduction method, and a program.

### BACKGROUND ART

As a method of reproducing sound with realistic feeling, a multichannel sound reproduction method of reproducing multichannel audio signals by using a plurality of speakers has been conventionally widely used. For example, a stereo (stereophonic) reproduction method using two speakers is a method of reproducing sound with realistic feeling as if a listener were in the place by reproducing audio signals collected by two independent microphones by using two corresponding speakers. In addition to the stereo reproduction method, various methods have been devised for giving a listener a better experience of sound with realistic feeling, such as a 5.1 channel surround reproduction method of reproducing sound by using more speakers and a binaural reproduction method of mounting a microphone on an environment imitating a human head (dummy head) to collect and reproduce sound reaching eardrums.

However, the above methods reproduce sound collected by microphones. This tends to greatly restrict a positional relationship between speakers to reproduce sound and listeners. For example, in the stereo reproduction method, balance of sound is lost when one speaker is too close, which greatly impairs a realistic feeling. Such a failure does not occur in the binaural reproduction method using headphones or the like, but the method cannot express sound felt by other than eardrums, such as heavy bass felt by the body. Thus, the method is inferior to other methods in terms of bodily sensation.

Therefore, in recent years, there have been devised various techniques based on a multichannel sound field reproduction method of physically reproducing a sound field itself formed by a sound source by combining a large number of speakers, which is different from a stereo surround sound reproduction method.

For example, Non Patent Literature 1 discloses a sound-source-reproduction type sound field reproduction technique that reproduces a spatial and physical wavefront of a sound source on the basis of a physical model, which is one of the multichannel sound field reproduction methods and is called a wave field synthesis acoustic technique. The wave field synthesis acoustic technique disclosed in Non Patent Literature 1 virtually reproduces a wavefront of a sound source recorded with high quality in a current sound field in a space different from the current sound field. A speaker array including a plurality of speakers outputs sound waves by adjusting a reproduction timing and power for each speaker so as to spatially and physically reproduce wavefronts at virtual sound source positions. When listening to the plurality of sound waves, the listener feels as if sounds were emitted from the virtual sound source positions.

In a case where a ground or a part of the ground in a real space is reproduced by using the wave field synthesis acoustic technique by taking an example of watching a soccer game, it is possible to obtain a realistic feeling of watching the game in the place by, for example, reproducing a ball kick sound, voice of a player, and the like according to a position of a sound source. Because the sound source is reproduced, the realistic feeling does not change even if the listener moves to various positions on the ground, unlike the stereo surround sound reproduction method. Also in a case of reproducing a concert venue, sound emitted by each instrument on a real stage is reproduced for each sound source. This gives a realistic feeling to the listener as if performance were actually performed. Further, even in a place where the listener has never experienced before, such as a position of the conductor or a position near the piano, the listener can obtain a realistic feeling as if listening to the sound in the place.

By using the wave field synthesis acoustic technique as described above, the listener can listen to sound as if a sound source were in the place and can enjoy various sounds with realistic feeling according to a position where the listener listens to the sound. Meanwhile, a general problem of realistic feeling reproduction techniques only using sound is that it is difficult for a listener who is not familiar with the sound to instantaneously understand what kind of sound is reproduced depending on content.

For example, in a case of reproducing sound of each instrument in a concert venue, a listener who is not familiar with instruments may not be able to immediately understand what the instrument is even when the listener approaches the certain instrument. In a case of watching a soccer game, even if a listener hears sound of players running around or sound of a ball thrown around, it is quite difficult to instantaneously understand which player does what kind of attack, which player does what kind of defense, or how fast the ball is thrown. That is, it may be difficult to understand content itself depending on the content or a listener even by the technique of reproducing a sound field itself, and the technique may be insufficient for an original purpose of enjoying the content.

In order to solve such a problem, there are many methods of improving understanding of the content and also improving a realistic feeling or quality of experience of the entire content also by using information other than sound, in particular, visual information of the content itself.

For example, in a case of reproducing a sound field at a concert venue, a real instrument is placed in each place where a sound field of the instrument is reproduced. The listener can instantaneously visually understand what instrument is sounding in which place while experiencing performance itself with sound. Therefore, the listener can enjoy the concert with a deeper understanding of the content.

In content that involves movement and motion of a sound source, such as soccer, for example, a video is presented in a real space by using a method in Non Patent Literature 2, thereby reproducing a realistic feeling by combining sound and video. Non Patent Literature 2 projects a video onto a translucent reflective film to present a virtual image of a player, a ball, or the like on a real object (for example, a table tennis table in a case of table tennis competition) in the real space, thereby providing visual information as if a competition were performed in the place.

### CITATION LIST

### Non Patent Literature

Non Patent Literature 1: Kimitaka Tsutsumi and Hideaki Takada, “Powerful Sound Effects at Audience Seats by Wave Field Synthesis” [online], [Searched on May 10, 2021], Internet <URL: https://www.ntt.co.jp/journal/1710/files/JN20171024.pdf>
Non Patent Literature 2: “Delivering ultra-high realistic feeling of being there to the world in real time—Promoting research and development of immersive telepresence technology ‘Kirari!’-”, [online], Feb. 18, 2015, [Searched on May 10, 2021], Internet <URL: https://www.ntt.co.jp/news2015/1502/150218b.html>

### SUMMARY OF INVENTION

### Technical Problem

In order to further understand and enjoy content, a method of using visual information of the content itself in combination with the sound field reproduction technique is effective for a listener who has a poor understanding of the content or in a case where it is difficult to understand the content only with sound.

Meanwhile, a listener who has a deep understanding of the content may acquire and understand various kinds of information only from sound, without depending on the visual information of the content itself. For example, in a goalball competition that is a sport for people with visual disabilities, a player instantaneously understands distinction of a player who pitches a ball or a position, pitching speed, direction, way of pitching, spinning/not spinning, and the like of the ball only on the basis of sound and then defends. It is difficult for a non-skilled person to instantaneously understand such information even by using the visual information (for example, a game video) of the content itself.

Those pieces of information obtained by a skilled person or understanding person are important for a deeper understanding of the content and eventually for increasing a realistic feeling and quality of experience of the entire content. In a sport for people with visual disabilities such as goalball, understanding information acquired by people with visual disabilities leads to understanding people with visual disabilities. Thus, it is socially important to intelligibly present those pieces of information to able-bodied people. However, it is difficult for a listener who has a poor understanding of the content to obtain those pieces of information even by using the visual information of the content itself in combination. That is, there is a problem that enjoyment of the content changes depending on skill or understanding of the listener.

An object of the present invention made in view of such circumstances is to present a virtual sound source created in a real space by a sound reproduction technique together with visual information representing a state and situation of the sound source, instead of visual information representing the sound source itself, thereby presenting implicit information that can be acquired by a skilled person and an understanding person and improving a deep understanding, realistic feeling, and quality of experience of content.

### Solution to Problem

In order to solve the above problem, a sound source reproduction device according to a first embodiment is a sound source reproduction device that presents, to a listener, a sound source together with visual information representing a state and situation of the sound source, the sound source reproduction device including: a sound source input unit that inputs sound source information recorded in advance in synchronization with time information; a sound source position input unit that inputs position information of a first sound source at the time; a first sound source attribute input unit that inputs first sound source attribute information for expressing an attribute of the first sound source at the time by using an image and reproducing the attribute in a real space; a sound source synthesis unit that generates a first virtual sound source for reproducing the first sound source in the real space by using the sound source information and the sound source position information at the time; a sound source reproduction unit that reproduces the virtual sound source in the real space; a first sound source attribute synthesis unit that generates a sound source attribute synthesis image for reproducing the first sound source attribute information in the real space by using the position information of the first sound source and the first sound source attribute information at the time; and a sound source attribute display unit that displays the sound source attribute synthesis image in the real space.

In order to solve the above problem, a sound source reproduction method according to the first embodiment is a sound source reproduction method in a sound source reproduction device that presents, to a listener, a sound source together with visual information representing a state and situation of the sound source, the sound source reproduction method including, by using the sound source reproduction device: a step of inputting sound source information recorded in advance in synchronization with time information; a step of inputting position information of a first sound source at the time; a step of inputting first sound source attribute information for expressing an attribute of the first sound source at the time by using an image and reproducing the attribute in a real space; a step of generating a first virtual sound source for reproducing the first sound source in the real space by using the sound source information and the sound source position information at the time; a step of reproducing the virtual sound source in the real space; a step of generating a sound source attribute synthesis image for reproducing the first sound source attribute information in the real space by using the position information of the first sound source and the first sound source attribute information at the time; and a step of displaying the sound source attribute synthesis image in the real space.

In order to solve the above problems, a program according to the first embodiment causes a computer to function as the above sound source reproduction device.

### Advantageous Effects of Invention

According to the present invention, in a scene for enjoying a realistic feeling of sound in a real space by reproducing a sound source, it is possible to visually express and add implicit information that is originally understood only by an understanding person and an experienced person. This makes it possible to promote not only the realistic feeling of the sound but also understanding of content.

### BRIEF DESCRIPTION OF DRAWINGS

FIG. 1 illustrates an example of using a sound source reproduction device according to a first embodiment.

FIG. 2 is a block diagram of a configuration example of the sound source reproduction device according to the first embodiment.

FIG. 3 illustrates a static table for specifying visual information with respect to attribute information.

FIG. 4 illustrates an example of visually expressing a sound source synthesis result in a real space.

FIG. 5 illustrates an example of visually expressing a sound source synthesis result in a real space.

FIG. 6 illustrates an example of visually expressing a sound source synthesis result in a real space.

FIG. 7 is a flowchart of an example of a sound source reproduction method executed by the sound source reproduction device according to the first embodiment.

FIG. 8 illustrates an example of using a sound source reproduction device according to a second embodiment.

FIG. 9 is a block diagram of a configuration example of the sound source reproduction device according to the second embodiment.

FIG. 10 is a flowchart of an example of a sound source reproduction method executed by the sound source reproduction device according to the second embodiment.

FIG. 11 is a block diagram of a schematic configuration of a computer that functions as a sound source reproduction device.

### DESCRIPTION OF EMBODIMENTS

### First Embodiment

Hereinafter, a sound source reproduction device according to a first embodiment will be described in detail by using a goalball experience system employing a wave field synthesis acoustic technique as an example.

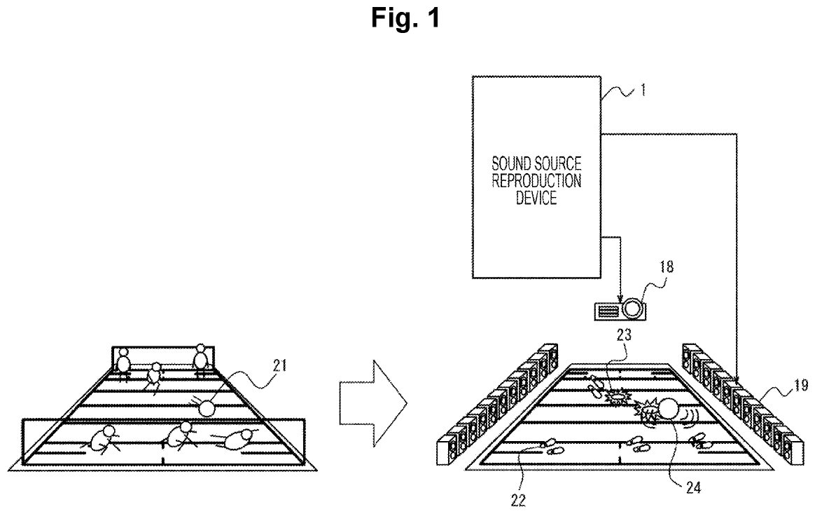

As illustrated in FIG. 1, a sound source reproduction device 1 according to the first embodiment is a device for building a system that reproduces, in a real space, a situation of an actual goalball game in a left diagram of FIG. 1 recorded in advance by visually expressing a state, situation, and the like of a sound source together with the sound source as illustrated in a right diagram of FIG. 1, thereby promoting understanding of a competition with realistic feeling by sound and enjoying content more than ever before. The sound source reproduction device 1 in FIG. 1 causes a speaker array 19 to reproduce a sound source such as a ball 21 including a bell therein by sound expression and also causes a display device 18 such as a projector to visually express a state and situation of the sound source by using an image.

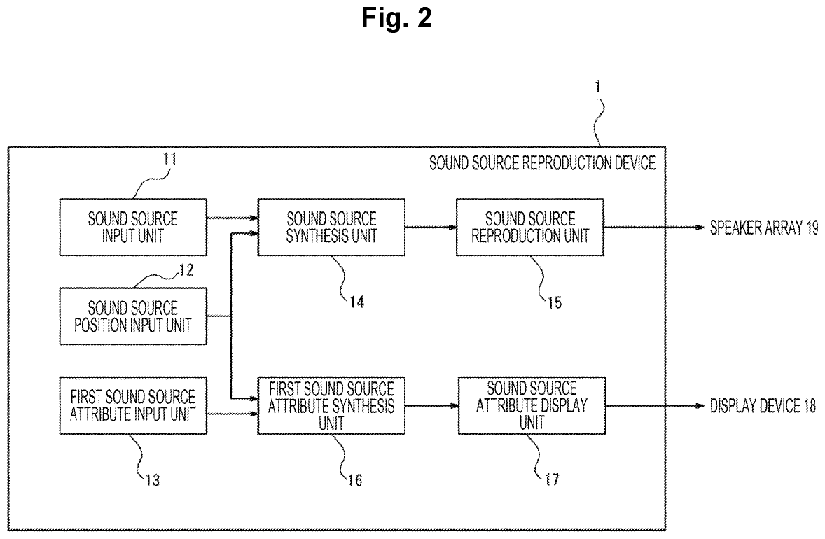

As illustrated in FIG. 2, the sound source reproduction device 1 according to the first embodiment includes: a sound source input unit 11 that inputs sound source information recorded in advance in synchronization with time information; a sound source position input unit 12 that inputs position information of a first sound source at the time; a first sound source attribute input unit 13 that inputs first sound source attribute information for expressing an attribute of the first sound source at the time by using an image and reproducing the attribute in a real space; a sound source synthesis unit 14 that generates a first virtual sound source for reproducing the first sound source in the real space by using the sound source information and the sound source position information at the time; a sound source reproduction unit 15 that reproduces the virtual sound source in the real space; a first sound source attribute synthesis unit 16 that generates a sound source attribute synthesis image for reproducing the attribute information of the first sound source in the real space by using the position information of the first sound source and the first sound source attribute information at the time; and a sound source attribute display unit 17 that displays the sound source attribute synthesis image in the real space.

The sound source input unit 11 receives a first sound source st at a certain time t of a game. As a simple example, the sound source input unit 11 receives a sound source such as a ball sound in goalball, that is, a ball bouncing sound, a ground ball sound, or a sound of a bell inside the ball with the progress of the game. In order to reproduce a situation of the game, the sound source input unit 11 can receive input of not only the above sound sources but also a wide variety of sound sources such as a player walking sound or running sound, a sound of hitting a floor to disturb the opponent team, and a signal or whistle sound of the start, end, or decision of the game by a referee. The sound source input unit 11 outputs the received first sound source st at the time t to the sound source synthesis unit 14.

The sound source position input unit 12 receives a sound source position pt of the first sound source st at the time t. There are various coordinate systems for determining position information, but, in the first embodiment, the center of a vertically placed court is set as a reference point, and a direction therefrom toward a goal on the near side is set as the y axis, a right direction therefrom is set as the x axis, and an upper direction from the court serving as a reference plane is set as the z axis. The court has a length of 18 m and a width of 9 m, and thus, in a case where there is a sound source at a position of 3 m from the right end, 2 m from a court end on the near side to the back, and 1 m in height, the position information is pt=(1.5 m, 7.0 m, 1.0 m). The sound source position input unit 12 outputs the received sound source position pt of the first sound source st at the time t to the sound source synthesis unit 14 and the first sound source attribute synthesis unit 16.

The sound source position input unit 12 may manually receive the sound source position pt of the first sound source st at the time t in advance or may receive the sound source position pt of the first sound source st in real time from a functional unit that automatically performs image processing and extracts a sound source position, the functional unit being included in a preceding stage or inside of the sound source position input unit 12.

Meanwhile, the first sound source attribute input unit 13 receives attribute information at of the first sound source st at the time t. The attribute information is information indicating a state and situation of the sound source and can be various kinds of information. The sound source reproduction device 1 uses the attribute information at including a speed Vt of a ball serving as a sound source, a direction Dt of the ball, and a type Tt of the ball. The first sound source attribute input unit 13 may manually set the attribute information at of the first sound source st at the time t in advance from, for example, a video obtained by capturing the situation of the game or may receive the attribute information at in real time from a functional unit that extracts the attribute information by using automatic analysis means, the functional unit being included in a preceding stage or inside of the first sound source attribute input unit 13. For example, the speed Vt of the ball can be easily automatically calculated on the basis of a moving distance dt of the ball between frames and a frame interval tf by extracting a shape of the ball from a video frame by template matching. The first sound source attribute input unit 13 outputs the attribute information at of the first sound source st to the first sound source attribute synthesis unit 16.

The sound source synthesis unit 14 generates a virtual sound source vt by using the received first sound source st and sound source position pt. The sound source reproduction technique may be the wave field synthesis technique as in Non Patent Literature 1 or other techniques, and any means may be used as long as the sound source can be reproduced in a space. In a case where Non Patent Literature 1 is taken as an example, sound (waveform), a delay time, a gain (degree of amplification), and the like are calculated for individual speakers of the speaker array 19 serving as an output destination. The sound source synthesis unit 14 outputs, to the sound source reproduction unit 15, a sound source synthesis result ct of synthesis of the sound source to reproduce the virtual sound source vt.

The sound source reproduction unit 15 receives the sound source synthesis result ct of the sound source synthesis unit 14 and reproduces the virtual sound source vt in the real space by using the speaker array 19 or the like. The sound source reproduction device 1 reproduces the virtual sound source vt in the real space in which the goalball court is reproduced in full size. When listening to the reproduced virtual sound source vt, the listener can feel realistic only with sound as if a real game is being played on the court.

Meanwhile, the first sound source attribute synthesis unit 16 first determines visual information It visually representing the state and situation of the sound source on the basis of the attribute information at and the sound source position pt of the first sound source st. Then, the first sound source attribute synthesis unit 16 generates a sound source attribute synthesis image (sound source attribute synthesis result At) of a different mode according to a speed of the first sound source st.

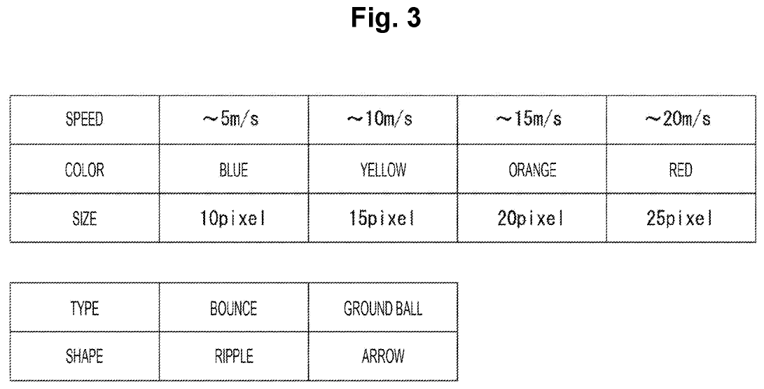

For example, the first sound source attribute synthesis unit 16 allocates color and size for the speed Vt of the ball, a direction for the direction Dt of the ball, and a shape for the type Tt of the ball as the visual information It. When determining the visual information It, the first sound source attribute synthesis unit 16 can easily specify the visual information It with respect to the attribute information at by, for example, preparing a static table illustrated in FIG. 3 in advance. FIG. 3 defines that the color and size serving as the visual information It change when the speed Vt of the ball changes, ripples are displayed when the ball bounces, and an arrow is displayed when the ball rolls as a ground ball, as the visual information It.

Alternatively, the first sound source attribute synthesis unit 16 may dynamically determine the visual information It by some algorithm. For example, in a case where the speed Vt is represented in stages of 0 to 40, luminance Ct can be dynamically determined according to the speed Vt by the following expression. In the following expression (1), a value of the luminance Ct increases and the color becomes brighter as the speed Vt of the ball increases.

$$\begin{matrix}[ Math . 1 ] & \\ {C}_{t} = 55 + \frac{200}{40} {V}_{t} & ( 1 )\end{matrix}$$

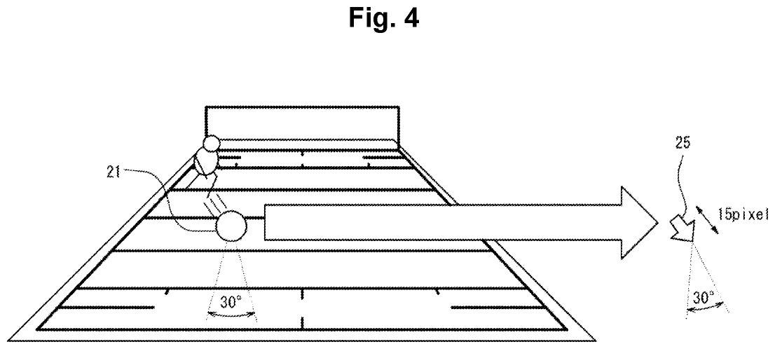

The first sound source attribute synthesis unit 16 synthesizes the visual information It obtained from the attribute information at of the first sound source st and outputs the synthesized visual information to the sound source attribute display unit 17 as the sound source attribute synthesis result At. For example, as illustrated in FIG. 4, in a case of a ground ball thrown at an angle of 30° from a left corner of the opponent court toward the center of the court on the near side at the speed of the ball 21 of 9 m/s, the first sound source attribute synthesis unit 16 refers to the static table of FIG. 3 and generates the sound source attribute synthesis result At having the color of yellow, the size of 15 pixels, the angle of 30°, and the shape of an arrow as the visual information It. The sound source attribute synthesis result At is generated as a sound source attribute synthesis image 25 illustrated in FIG. 4 on the basis of the visual information It.

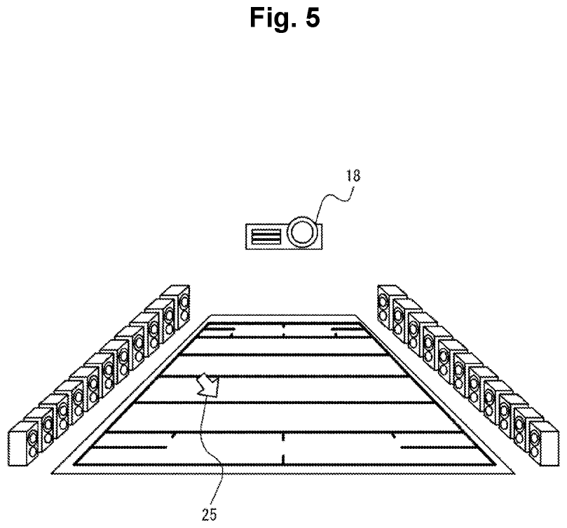

Next, the sound source attribute display unit 17 adds the state and situation of the sound source with a visual expression by displaying the sound source attribute synthesis result At as the sound source attribute synthesis image 25 in the same real space as the sound source. Specifically, as illustrated in FIG. 5, this can be easily achieved by projecting the sound source attribute synthesis image 25 onto the real space by using the display device 18 such as a projector. When the sound source attribute synthesis result At is displayed in the real space, the sound source attribute synthesis result is displayed at the same position as the sound source position pt by using the sound source position pt of the first sound source st. Therefore, the listener can listen to the actual sound of the first sound source st with realistic feeling and, at the same time, can easily visually grasp in which state or situation the sound is.

In FIG. 5, because the ball was a ground ball, the ball is two-dimensionally displayed on a surface of the court. The display device 18 such as a projector cannot express a height direction, and thus a sound with height such as a sound of a whistle of a referee cannot be directly displayed in the space. In such a case, the sound source attribute display unit 17 can correct and display the sound source attribute synthesis result At depending on the display device. In a case where sound source coordinates ph of the sound of the whistle are (−9.0 m, −6.5 m, 1.7 m), the sound source attribute synthesis result At is visually expressed at the feet of the person blowing the whistle by, for example, correcting the height direction to sound source coordinates ph′ (−9.0 m, −6.5 m, 0.0 m). In a case of using the display device disclosed in Non Patent Literature 2, the display device can display a virtual image as if there is an actual object in the place and can therefore visually express the sound source coordinates ph with height as they are.

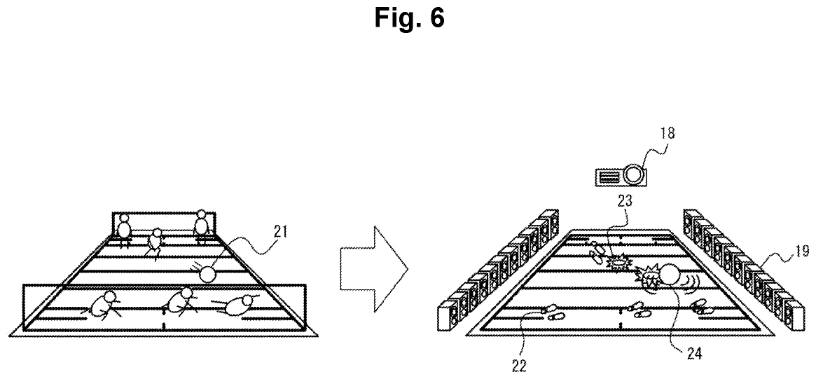

The left diagram of FIG. 6 illustrates an actual situation of a game of a goalball competition and illustrates a situation in which the ball 21 is moving. Meanwhile, the right diagram illustrates reproduction of the game situation in the left diagram by the sound source reproduction device 1. A synthesized sound source 24 is reproduced as sound by the speaker array 19, and footprints 22 of competitors and ripples 23 of the bouncing ball 21 are additionally displayed as the sound source attribute synthesis image 25 by the display device 18 such as a projector.

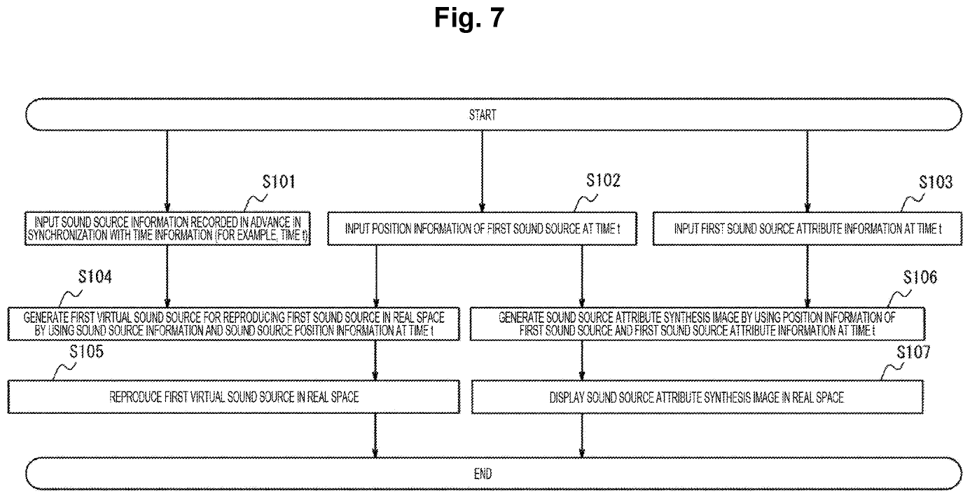

FIG. 7 is a flowchart of an example of a sound source reproduction method executed by the sound source reproduction device 1.

In step S101, the sound source input unit 11 inputs sound source information recorded in advance in synchronization with time information.

In step S102, the sound source position input unit 12 inputs position information of a first sound source at the time.

In step S103, the first sound source attribute input unit 13 inputs first sound source attribute information for expressing an attribute of the first sound source at the time by using an image and reproducing the attribute in a real space.

In step S104, the sound source synthesis unit 14 generates a first virtual sound source for reproducing the first sound source in the real space by using the sound source information and the sound source position information at the time.

In step S105, the sound source reproduction unit 15 reproduces the first virtual sound source in the real space.

In step S106, the first sound source attribute synthesis unit 16 generates a sound source attribute synthesis image for reproducing the attribute information of the first sound source in the real space by using the position information of the first sound source and the first sound source attribute information at the time.

In step S107, the sound source attribute display unit 17 displays the sound source attribute synthesis image in the real space.

As described above, as the state and situation of the sound source change every moment according to the time t, a visual expression thereof is displayed in the real space at the same position as that of the sound source by using the sound source reproduction device 1. Therefore, in a scene for enjoying a realistic feeling of sound in the real space by reproducing a sound source, the sound source reproduction device 1 according to the present embodiment can visually express and add implicit information that is originally understood only by an understanding person and an experienced person. This promotes not only the realistic feeling of the sound but also understanding of content.

In a case of a goalball competition, a skilled player instantaneously grasps a position and motion of an opponent on the basis of the player's footsteps and also grasps a direction, strength, speed, or the like on the basis of a ball sound such as a bouncing sound. By using the sound source reproduction device 1, those pieces of information that are originally understood only by sound are intelligibly visually expressed as illustrated in the right diagram of FIG. 6. For example, when a ground ball is thrown, an arrow indicating a moving direction of the ball is intelligibly and successively displayed on a floor surface together with a speed of the ball as the ball moves. Therefore, it is possible to see a state and situation of the sound at a glance with a realistic feeling of the sound. Thus, even a person who has not experienced the competition can understand a game situation and the like mainly by sound and can also understand what people with visual disabilities can grasp from sound. Therefore, it is possible not only to enjoy the competition more, but also to more deeply understand people with visual disabilities.

### Second Embodiment

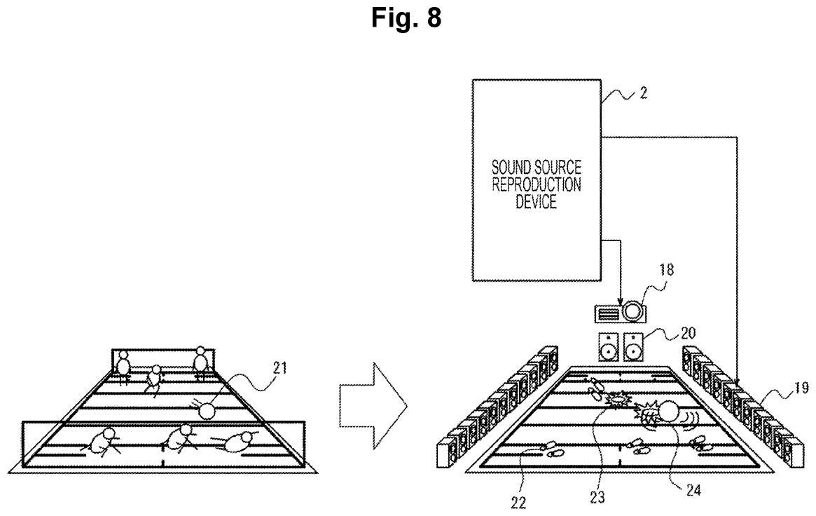

Next, a sound source reproduction device according to a second embodiment will be described in detail with reference to FIGS. 8 to 10 by using a goalball experience system employing the wave field synthesis acoustic technique as an example.

As illustrated in FIG. 8, a sound source reproduction device 2 according to the second embodiment visually expresses an attribute of a sound source in a real space via a display device 18 such as a projector and reproduces the attribute of the sound source in the real space by sound via a speaker 20 different from a speaker array 19.

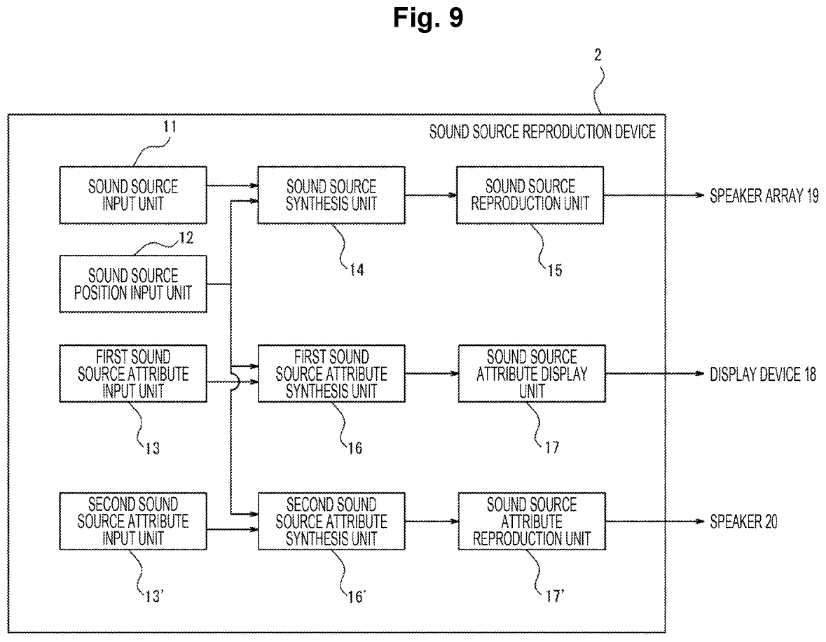

FIG. 9 is a block diagram of a configuration example of the sound source reproduction device 2 according to the second embodiment. The sound source reproduction device 2 in FIG. 9 includes a sound source input unit 11, a sound source position input unit 12, a first sound source attribute input unit 13, a second sound source attribute input unit 13′, a sound source synthesis unit 14, a sound source reproduction unit 15, a first sound source attribute synthesis unit 16, a second sound source attribute synthesis unit 16′, a sound source attribute display unit 17, and a sound source attribute reproduction unit 17′. The sound source reproduction device 2 is different from the sound source reproduction device 1 according to the first embodiment in that the sound source reproduction device 2 further includes the second sound source attribute input unit 13′, the second sound source attribute synthesis unit 16′, and the sound source attribute reproduction unit 17′. The same components as those of the first embodiment will be denoted by the same reference signs as those of the first embodiment, and the description thereof will be omitted as appropriate.

The second sound source attribute input unit 13′ receives attribute information bt of a second sound source st′ at a time t. The attribute information bt is information indicating a state and situation of the second sound source st′ and can be various kinds of information. The second sound source attribute input unit 13′ of the sound source reproduction device 2 uses the attribute information bt forming, for example, walking sounds of people such as a competitor and a referee, a ball bouncing sound, and a ground ball sound. For example, by using different sounds for walking sounds of Mr. A and Mr. B, it is possible to intelligibly tell who is located where to a listener. The second sound source attribute input unit 13′ outputs the attribute information bt of the second sound source st′ to the second sound source attribute synthesis unit 16′.

The second sound source attribute synthesis unit 16′ first determines sound information jt for reproducing an attribute of the sound source in a real space by sound by using the attribute information bt and a sound source position pt of the second sound source st′. Then, in a case where there is a plurality of second sound sources, the second sound source attribute synthesis unit 16′ generates second virtual sound sources (sound source attribute synthesis results Bt) of respective different modes. For example, the second sound source attribute synthesis unit 16′ allocates different sounds as sound information corresponding to walking sounds of a competitor and a referee. When determining the sound information jt, the second sound source attribute synthesis unit 16′ synthesizes the sound source attribute synthesis result Bt and outputs the sound source attribute synthesis result Bt to the sound source attribute reproduction unit 17′.

The sound source attribute reproduction unit 17′ reproduces the synthesized sound source attribute synthesis result Bt by sound in the same real space as the sound source, thereby adding a state and a situation serving as the attribute of the sound source by sound expression. Specifically, as illustrated in FIG. 8, this addition by sound expression can be easily achieved by reproducing the sound in the real space by using the speaker 20 including two left and right speakers in addition to the speaker array 19. When the sound source attribute synthesis result Bt is reproduced in the real space, the sound source attribute synthesis result is reproduced at the same position as the sound source position pt by using the sound source position pt of the second sound source st′.

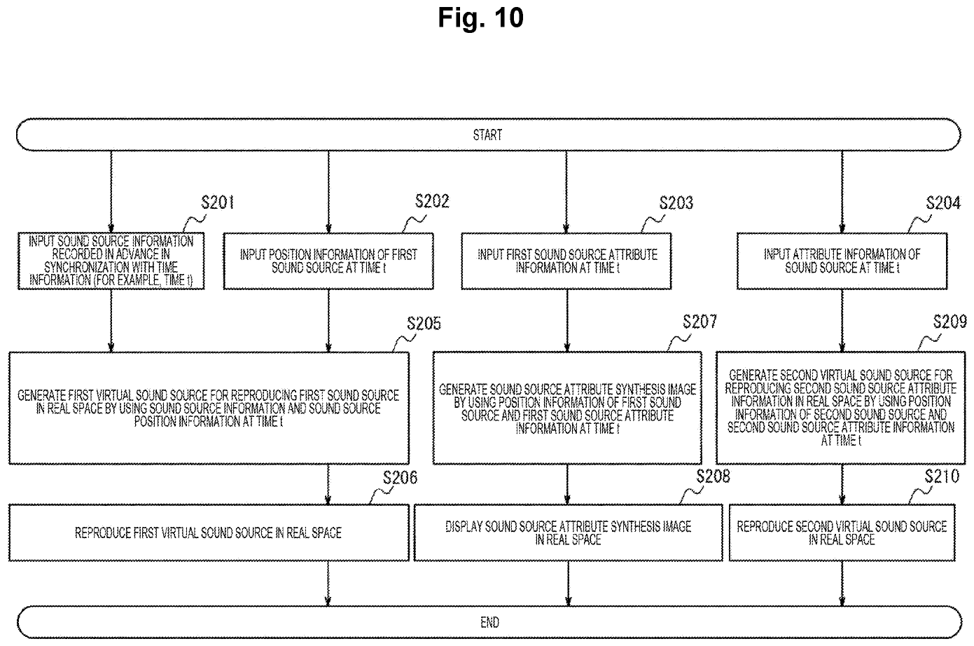

FIG. 10 is a flowchart of an example of a sound source reproduction method executed by the sound source reproduction device 2.

In step S201, the sound source input unit 11 inputs sound source information recorded in advance in synchronization with time information.

In step S202, the sound source position input unit 12 inputs position information of a first sound source at the time.

In step S203, the first sound source attribute input unit 13 inputs first sound source attribute information for expressing an attribute of the first sound source at the time by using an image and reproducing the attribute in a real space.

In step S204, the second sound source attribute input unit 13′ inputs second sound source attribute information for expressing an attribute of a second sound source at the time by sound and reproducing the attribute in the real space.

In step S205, the sound source synthesis unit 14 generates a first virtual sound source for reproducing the first sound source in the real space by using the sound source information and the sound source position information at the time.

In step S206, the sound source reproduction unit 15 reproduces the first virtual sound source in the real space.

In step S207, the first sound source attribute synthesis unit 16 generates a sound source attribute synthesis image for reproducing the attribute information of the first sound source in the real space by using the position information of the first sound source and the first sound source attribute information at the time.

In step S208, the sound source attribute display unit 17 displays the sound source attribute synthesis image in the real space.

In step S209, the second sound source attribute synthesis unit 16′ generates a second virtual sound source for reproducing attribute information of the second sound source in the real space by using position information of the second sound source and the second sound source attribute information at the time.

In step S210, the sound source attribute reproduction unit 17′ reproduces the second virtual sound source in the real space.

By using the sound source reproduction device 2 according to the present embodiment, it is possible to further easily grasp the attribute of the second sound source st′ by combining the visual information and the sound information. This further promotes understanding of content by a student, as compared with a case of the sound source reproduction device 1.

The sound source input unit 11, the sound source position input unit 12, the first sound source attribute input unit 13, the second sound source attribute input unit 13′, the sound source synthesis unit 14, the sound source reproduction unit 15, the first sound source attribute synthesis unit 16, the second sound source attribute synthesis unit 16′, the sound source attribute display unit 17, and the sound source attribute reproduction unit 17′ in the above sound source reproduction devices 1 and 2 form a part of a control arithmetic circuit (controller). The control arithmetic circuit may be configured by dedicated hardware such as an application specific integrated circuit (ASIC) or a field-programmable gate array (FPGA), may be configured by a processor, or may be configured to include both dedicated hardware and a processor.

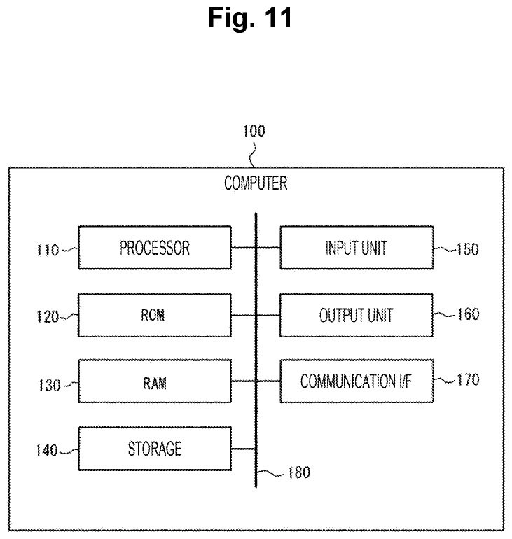

In order to cause the above sound source reproduction devices 1 and 2 to function, it is also possible to use a computer capable of executing a program command. FIG. 11 is a block diagram of a schematic configuration of a computer that functions as the sound source reproduction device 1. Here, a computer 100 may be a general-purpose computer, a dedicated computer, a workstation, a personal computer (PC), an electronic note pad, or the like. The program command may be a program code, code segment, or the like for executing a necessary task.

As illustrated in FIG. 11, the computer 100 includes a processor 110, a read only memory (ROM) 120, a random access memory (RAM) 130, and a storage 140 as a storage unit, an input unit 150, an output unit 160, and a communication interface (I/F) 170. The components are communicably connected to each other via a bus 180. In the above sound source reproduction device 1, the sound source input unit 11, the sound source position input unit 12, and the first sound source attribute input unit 13 may serve as the input unit 150, and the sound source reproduction unit 15 and the sound source attribute display unit 17 may serve as the output unit 160.

The ROM 120 stores various programs and various kinds of data. The RAM 130 temporarily stores a program or data as a work area. The storage 140 includes a hard disk drive (HDD) or a solid state drive (SSD) and stores various programs including an operating system and various kinds of data. In the present invention, the program according to the present invention is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like and may be configured by a plurality of the same or different kinds of processors. The processor 110 reads the program from the ROM 120 or the storage 140 and executes the program by using the RAM 130 as a work area, thereby controlling each of the above components and performing various kinds of arithmetic processing. At least some of those processing contents may be implemented by hardware.

The program may be recorded in a recording medium that can be read by the computer 100. By using such a recording medium, the program can be installed in the computer 100. Here, the recording medium on which the program is recorded may be a non-transitory recording medium. The non-transitory recording medium is not particularly limited, but may be, for example, a CD-ROM, a DVD-ROM, or a universal serial bus (USB) memory. The program may be downloaded from an external device via a network.

Regarding the above embodiments, the following supplementary notes are further disclosed.

### (Supplementary Note 1)

A sound source reproduction device that presents, to a listener, a sound source together with visual information representing a state and situation of the sound source, the sound source reproduction device including
a control unit that inputs sound source information recorded in advance in synchronization with time information, inputs position information of a first sound source at the time, inputs first sound source attribute information for expressing an attribute of the first sound source at the time by using an image and reproducing the attribute in a real space, generates a first virtual sound source for reproducing the first sound source in the real space by using the sound source information and the sound source position information at the time, reproduces the virtual sound source in the real space, generates a sound source attribute synthesis image for reproducing the first sound source attribute information in the real space by using the position information of the first sound source and the first sound source attribute information at the time, and displays the sound source attribute synthesis image in the real space.

### (Supplementary Note 2)

The sound source reproduction device according to Supplementary Note 1, in which
the control unit
generates the sound source attribute synthesis image of a different mode according to a speed of the first sound source.

### (Supplementary Note 3)

The sound source reproduction device according to Supplementary Note 1, in which
the control unit
inputs the position information of the first sound source and position information of a second sound source at the time, inputs second sound source attribute information for expressing an attribute of the second sound source at the time by sound and reproducing the attribute in the real space, generates a second virtual sound source for reproducing the second sound source attribute information in the real space by using the position information of the second sound source and the attribute information of the second sound source at the time, and reproduces the second virtual sound source in the real space.

### (Supplementary Note 4)

The sound source reproduction device according to Supplementary Note 3, in which
in a case where there is a plurality of the second sound sources, the control unit generates the second virtual sound sources of different modes.

### (Supplementary Note 5)

A sound source reproduction method in a sound source reproduction device that presents, to a listener, a sound source together with visual information representing a state and situation of the sound source,
the sound source reproduction method including, by using the sound source reproduction device:
a step of inputting sound source information recorded in advance in synchronization with time information; a step of inputting position information of a first sound source at the time; a step of inputting first sound source attribute information for expressing an attribute of the first sound source at the time by using an image and reproducing the attribute in a real space; a step of generating a first virtual sound source for reproducing the first sound source in the real space by using the sound source information and the sound source position information at the time; a step of reproducing the virtual sound source in the real space; a step of generating a sound source attribute synthesis image for reproducing the attribute information of the first sound source in the real space by using the position information of the first sound source and the first sound source attribute information at the time; and a step of displaying the sound source attribute synthesis image in the real space.

### (Supplementary Note 6)

The sound source reproduction method according to Supplementary Note 5, further including: a step of inputting second sound source attribute information for expressing an attribute of the second sound source at the time by sound and reproducing the attribute in the real space; a step of generating a second virtual sound source for reproducing the second sound source attribute information in the real space by using the position information of the second sound source and the second sound source attribute information at the time; and a step of reproducing the second virtual sound source in the real space.

### (Supplementary Note 7)

A non-transitory storage medium storing a program executable by a computer, the non-transitory storage medium storing a program for causing the computer to function as the information presentation device according to Supplementary Note 1 or 2.

Although the above-described embodiments have been described as representative examples, it is apparent to those skilled in the art that many modifications and substitutions can be made within the spirit and scope of the present invention. Therefore, it should be understood that the present invention is not limited by the above-described embodiments, and various modifications or changes can be made without departing from the scope of the claims. For example, a plurality of configuration blocks illustrated in the configuration diagrams of the embodiments can be combined into one, or one configuration block can be divided.

### REFERENCE SIGNS LIST

1 Sound source reproduction device
2 Sound source reproduction device
11 Sound source input unit
12 Sound source position input unit
13 First sound source attribute input unit
13′ Second sound source attribute input unit
14 Sound source synthesis unit
15 Sound source reproduction unit
16 First sound source attribute synthesis unit
16′ Second sound source attribute synthesis unit
17 Sound source attribute display unit
17′ Sound source attribute reproduction unit
18 Display device
19 Speaker array
20 Speaker
100 Computer
110 Processor
120 ROM
130 RAM
140 Storage
150 Input unit
160 Output unit
170 Communication interface (I/F)
180 Bus

1. A sound source reproduction device comprising a processor configured to execute operations comprising:
receiving, as input, sound source information recorded in advance in synchronization with time information of a time;
receiving, as input, position information of a first sound source at the time;
receiving, as input, first sound source attribute information for expressing an attribute of the first sound source at the time by using an image and for reproducing the attribute in a real space;
generating a first virtual sound source for reproducing the first sound source in the real space by using the sound source information and the sound source position information at the time;
reproducing the virtual sound source in the real space;
generating a sound source attribute synthesis image for reproducing the first sound source attribute information in the real space by using the position information of the first sound source and the first sound source attribute information at the time; and
displaying the sound source attribute synthesis image in the real space.

2. The sound source reproduction device according to claim 1, wherein the generating the sound source attribute synthesis image further comprises generating the sound source attribute synthesis image of a different mode according to a speed of the first sound source.

3. The sound source reproduction device according to claim 1, wherein
the receiving the position information further comprises receiving, as input, the position information of the first sound source and position information of a second sound source at the time, and
the processor further configured to execute operations comprising:
receiving, as input second sound source attribute information for expressing an attribute of the second sound source at the time by sound and reproducing the attribute in the real space,
generating a second virtual sound source for reproducing the second sound source attribute information in the real space by using the position information of the second sound source and the second sound source attribute information at the time, and
reproducing the second virtual sound source in the real space.

4. The sound source reproduction device according to claim 3, wherein, when there is a plurality of the second sound sources, the generating the second sound source further comprises generating the second virtual sound sources of different modes.

5. A sound source reproduction method for presenting, to a listener, a sound source together with visual information representing a state and situation of the sound source, comprising:
a step of inputting sound source information recorded in advance in synchronization with time information of a time;
a step of inputting position information of a first sound source at the time;
a step of inputting first sound source attribute information for expressing an attribute of the first sound source at the time by using an image and reproducing the attribute in a real space;
a step of generating a first virtual sound source for reproducing the first sound source in the real space by using the sound source information and the sound source position information at the time;
a step of reproducing the virtual sound source in the real space;
a step of generating a sound source attribute synthesis image for reproducing the first sound source in the real space by using the position information of the first sound source and the first sound source attribute information at the time; and
a step of displaying the sound source attribute synthesis image in the real space.

6. The sound source reproduction method according to claim 5, further comprising:
a step of inputting the position information of the first sound source and position information of a second sound source at the time;
a step of inputting second sound source attribute information for expressing an attribute of the second sound source at the time by sound and for reproducing the attribute in the real space;
a step of generating a second virtual sound source for reproducing the second sound source attribute information in the real space by using the position information of the second sound source and the second sound source attribute information at the time; and
a step of reproducing the second virtual sound source in the real space.

7. A computer-readable non-transitory recording medium storing computer-executable program instructions that when executed by a processor cause a computer to execute operations comprising:
receiving, as input, sound source information recorded in advance in synchronization with time information of a time;
receiving, as input, position information of a first sound source at the time;
receiving, as input, first sound source attribute information for expressing an attribute of the first sound source at the time by using an image and for reproducing the attribute in a real space;
generating a first virtual sound source for reproducing the first sound source in the real space by using the sound source information and the sound source position information at the time;
reproducing the virtual sound source in the real space;
generating a sound source attribute synthesis image for reproducing the first sound source attribute information in the real space by using the position information of the first sound source and the first sound source attribute information at the time; and
displaying the sound source attribute synthesis image in the real space.

8. The sound source reproduction device according to claim 1, wherein the first sound source includes a ball used in a soccer, the attribute of the first sound source includes a velocity of movement of the ball, and
wherein the first virtual sound source for reproducing the first sound source in the real space includes an image of the ball with a color representing the velocity of the movement of the ball and with a size representing a position of the ball according to the position information of the first sound source.

9. The sound source reproduction device according to claim 1, wherein the sound source attribute synthesis image includes a visual representation of the first sound source and a visual indication of a direction and a speed of the first sound source in motion.

10. The sound source reproduction method according to claim 5, wherein the generating the sound source attribute synthesis image further comprises generating the sound source attribute synthesis image of a different mode according to a speed of the first sound source.

11. The sound source reproduction method according to claim 5, wherein
the receiving the position information further comprises receiving, as input, the position information of the first sound source and position information of a second sound source at the time, and
the processor further configured to execute operations comprising:
receiving, as input second sound source attribute information for expressing an attribute of the second sound source at the time by sound and reproducing the attribute in the real space,
generating a second virtual sound source for reproducing the second sound source attribute information in the real space by using the position information of the second sound source and the second sound source attribute information at the time, and
reproducing the second virtual sound source in the real space.

12. The sound source reproduction method according to claim 11, wherein,
when there is a plurality of the second sound sources, the generating the second sound source further comprises generating the second virtual sound sources of different modes.

13. The sound source reproduction method according to claim 5, wherein the first sound source includes a ball used in a soccer, the attribute of the first sound source includes a velocity of movement of the ball, and
wherein the first virtual sound source for reproducing the first sound source in the real space includes an image of the ball with a color representing the velocity of the movement of the ball and with a size representing a position of the ball according to the position information of the first sound source.

14. The sound source reproduction method according to claim 5, wherein the sound source attribute synthesis image includes a visual representation of the first sound source and a visual indication of a direction and a speed of the first sound source in motion.

15. The computer-readable non-transitory recording medium according to claim 7, wherein the generating the sound source attribute synthesis image further comprises generating the sound source attribute synthesis image of a different mode according to a speed of the first sound source.

16. The computer-readable non-transitory recording medium according to claim 7, wherein
the receiving the position information further comprises receiving, as input, the position information of the first sound source and position information of a second sound source at the time, and
the processor further configured to execute operations comprising:
receiving, as input second sound source attribute information for expressing an attribute of the second sound source at the time by sound and reproducing the attribute in the real space,
generating a second virtual sound source for reproducing the second sound source attribute information in the real space by using the position information of the second sound source and the second sound source attribute information at the time, and
reproducing the second virtual sound source in the real space.

17. The computer-readable non-transitory recording medium according to claim 16, wherein, when there is a plurality of the second sound sources, the generating the second sound source further comprises generating the second virtual sound sources of different modes.

18. The computer-readable non-transitory recording medium according to claim 7, wherein the first sound source includes a ball used in a soccer, the attribute of the first sound source includes a velocity of movement of the ball, and
wherein the first virtual sound source for reproducing the first sound source in the real space includes an image of the ball with a color representing the velocity of the movement of the ball and with a size representing a position of the ball according to the position information of the first sound source.

19. The computer-readable non-transitory recording medium according to claim 7, wherein the sound source attribute synthesis image includes a visual representation of the first sound source and a visual indication of a direction and a speed of the first sound source in motion.
